(19) United States
(12) Patent Application Publication
(10) Pub. No.: US 2006/0288843 A1
(43) Pub. Date: Dec. 28, 2006

(54) INTERNET-BASED MUSIC SYSTEM

(76) Inventor: Glenn D. Helton JR., Marysville, WA (US)

Correspondence Address: GREENBERG & LIEBERMAN, LLC, 2141 WISCONSIN AVE, N.W., SUITE C-2, WASHINGTON, DC, 20007, US

(21) Appl. No.: 11/160,511

(22) Filed: Jun. 27, 2005

(51) Int. Cl. G10H 1/00

(52) U.S. Cl. 84/600

(57) ABSTRACT

A system for having separate recordings of instruments playing the same song. A user is able to choose which instruments will be combined so that a final song can be created by merging the selected instruments together. In this way, the user can obtain a song that is missing at least one instrument, and then the user can play the user's instruments in place of the at least one missing instrument.

### FIELD OF THE INVENTION

The present invention is an online system that allows a user to look up a track of music, choose that track of music for downloading and only have certain instruments in that track that is downloaded. For example, according to the present invention, the user could go on line and look up a song that has a drum, that has a lead guitar, that has a bass guitar, that has a synthesizer and that has a tambourine. The user could choose to download the track of music with only the lead guitar and the drums, and all the other instruments missing from the track. Thus, the user would be able to play the downloaded track, and the user and a group of friends would be able to provide the missing instruments as they play along with the downloaded track.

### BACKGROUND OF THE INVENTION

It can be said that there are two major milestones when learning to play a musical instrument. The first milestone is actually understanding how to create different sounds from the musical instrument, so that someone listening to the user play would actually understand a song that the user is playing. For example, if a user picks up a guitar, the user needs to be able to accurately reproduce the tones that are necessary, so that somebody listening to the user play the guitar would recognize the song. Through hours and hours of practice and proper instruction, sufficient mastery of the guitar can be achieved, so that the user can reproduce songs, maybe basic at first, and then later, more complex songs, so that someone listening to the user play would recognize those songs.

The second milestone is being able to play a musical instrument, not just alone, but in concert with other musical instruments. Often times, the user cannot just play the guitar, for example, according to a song sheet, but the user must delay playing certain notes, or adapt the user's playing style, to the music for other musicians that are part of a concert.

Practice, so that the user achieves a second milestone, requires the user to actually play along with others. It is impossible for a user to play a guitar, for example, sitting in the user's basement, isolated without other band members, such as drum players, other guitar players, a vocalist, et cetera. There is a need for the user to join a band where several individuals would play their instruments together in a garage, for example, or in a studio, so that the user could achieve the second milestone, which is being able to play the user's instrument along with others, and properly delay increased volume, decreased volume, and explore the different nuances that are necessary when you play with others, as opposed to just playing solo. Many individuals, however, find it difficult to find the time to practice with others. The demands of daily work schedules, possible physical disabilities and physically being isolated, in terms of location, from others capable of playing along with the user all contribute to preventing the user from reaching the second milestone.

Thus, there is a need for a system that allows a user of a musical instrument to play that musical instrument with others, so that the user can actually master the subtle nuances associated with playing in a band or in a concert. For example, there is a need for a user that plays a flute to have an experience of playing in an orchestra, even though the user might never physically be able to sit amongst members of an orchestra. Without being able to play with others, the user will never master the second milestone, and although the user might be capable of playing an instrument according to sheet music, the user will not be competent in playing the user's instrument in a group setting. Furthermore, there are certain musical performers recognized in their particular field because of a certain style or a certain ability to create music with an instrument. Very few average musicians, or even experienced musicians, are fortunate enough to have the occasion to play with such remarkable individuals.

Thus, there is a need for a system that allows any musician to be able to play alongside renowned musicians. Moreover, there is a need for allowing any musician to be able to play with other musicians for a small, or rather insignificant, cost. Thus, there needs to be a system devised so that any musician would be able to, within reason, afford to play with remarkable musicians, so to experience, if nothing else, the subtle slowdowns, increased volume, lower volumes and other musical nuances that all go along with playing with a remarkable musician in a particular field.

Japanese Patent Publication No. 2,001,236,082A, published on Aug. 31, 2001, by Uenishi Futoshi, shows a karaoke system applying Internet by means of portable telephone PHS. Futoshi's device, like many devices in the field, offers karaoke music delivery and/or reservations via the telephone or other Internet means. Unlike the present invention, Futoshi's device does not allow a user to practice the user's musical instrument with prerecorded music, so that the user's musical instrument is absent from the prerecorded music track and the user can actually play that instrument to complete the track the way the track should sound. The website, www.GuitarPort.com provides a service called Guitar Port Online that allows the user to download tracks of music without a lead guitar in the track of music. Thus, via Guitar Port Online, a user could obtain a track of music and listen to the music while playing the user's guitar, and in such a way, the user would be able to learn how to play with others.

Unlike the present invention, Guitar Port Online does not offer the ability to remove one or two or three instruments from a track. The user is only able to download a track of music without the lead guitar, but the user cannot remove the drums and the lead guitar and the bass guitar. Removing more than just the lead guitar would be desirable if the user does not play the lead guitar, but actually plays the drums, or if the user has a friend who plays the drums, and the user plays the lead guitar, and a friend who plays another instrument, the user would want to download a track with three instruments removed, but that is not possible on Guitar Port Online.

Thus, there is a need for an invention that allows a track of music to be downloaded wherein the user can select a track of music without the instruments that the user is going to play when practicing that track.

### SUMMARY OF THE INVENTION

The present invention relates to music supplied over the Internet. More particularly, the present invention provides tracks of music to a user, so that the user can practice playing a musical instrument.

### DETAILED DESCRIPTION OF THE PREFERRED EMBODIMENT(S)

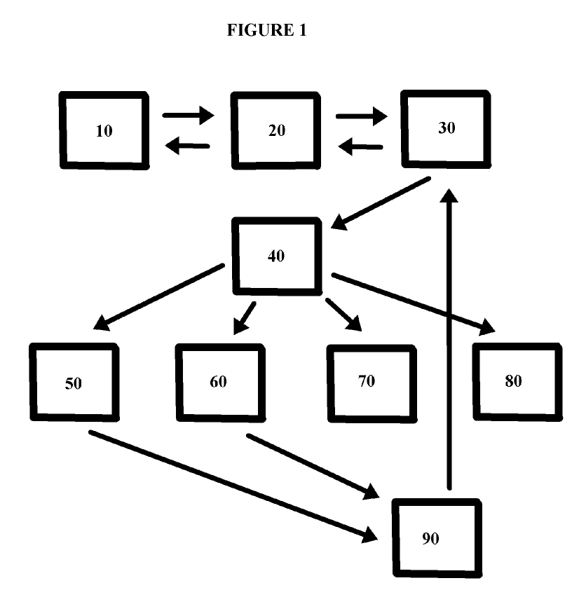

As shown in FIG. 1, the present invention would operate with a user's computer (10), an ISP, or an Internet Service Provider (20) and a music server (30) operated by a business. A user would turn on the user's computer (10), log onto the Internet through an ISP (20) connection and access, whether through a conventional browser or through a secure logon via the Internet, music server (30). Once the user can access music server (30), the user would choose a song. In the example in FIG. 1, the user chooses Song 40 to be downloaded to user's computer (10). In actuality, Song 40 is composed of instrument one track (50), instrument two track (60), instrument three track (70) and instrument four track (80).

Song 40 has four instruments and each instrument has been isolated on a separate track, such that instrument one track (50) might have a guitar. Instrument two track (60) might have a piano. Instrument three track (70) might have drums. Instrument four track (80) might have a tambourine. Thus, although the user perceives Song 40 as merely being one song, music server (30) has four tracks, instrument one track (50), instrument two track (60), instrument three track (70) and instrument four track (80) that together, make up Song 40 as the user would recognize Song 40.

To create instrument track one (50), instrument two track (60), instrument three track (70) and instrument four track (80), Song 40 was run through a conventional analysis, so that only one instrument could be isolated per track. Such conventional means to isolate individual instruments on a musical recording is well known and is not the subject of the present invention. The importance of having Song 40 broken down into instrument one track (50), instrument two track (60), instrument three track (70) and instrument four track (80) is crucial to the operation of the present invention. The user would not be able to determine which instruments it wants as part of Song 40 unless instrument one track (50), instrument two track (60), instrument three track (70) and instrument four track (80) had been separated out, so that each instrument that is part of Song 40 had its own track.

In a sense, the present invention could be summed up very simply, in that it has a separate track for each instrument of a song, and when the user requests a song, the user actually selects the tracks that would be put together to create the version of the song that will be downloaded by the user.

Thus, per FIG. 1, the user selects instrument one track (50) and instrument two track (60) to be combined for a created track (90). Instrument three track (70) and instrument four track (80) are not desired by the user, and thus, when the user downloads created track (90), they will be absent. FIG. 1 represents a situation where the user might want instrument one track (50), that would be the lead guitar, and instrument two track (60), that would be the drums. The user that might play the tambourine and also and keyboard might want the tambourine and the keyboard track removed from Song 40. The tambourine track could be instrument three track (70) and the keyboard track could be instrument four track (80). Once created track (90) has been assembled, created track (90) would then be delivered to the user's computer (10) via ISP (20) from music server (30).

The present invention assembles instrument one track (50) and instrument two track (60) using conventional technology that can record two tracks together with the proper timing, so that a user listening would not be able to discern that the instruments had at one time been separated on separate tracks. Because created track (90) is available to be downloaded to user's computer (10), the present invention makes choosing the instruments in a desired song relatively easy and accessible for anyone, essentially anywhere, so long as an Internet connection and a computer, or similar device, is available.

Alternatively, created track (90) can be burned to a CD from music server (30) and then simply mailed to the user.

What is claimed is:

1. A system for creating music for a user from an existing song, comprising: separating the song into separate tracks, each said track having one instrument; and providing the user with at least one of said tracks.

2. The system of claim 1, wherein said providing the user with at least one of said tracks is allowing the user to download at least one of said tracks.

3. The system of claim 1, wherein said providing the user with at least one of said tracks is burning at least one of said tracks to a CD for the user.

4. The system of claim 1, further comprising storing the song on a computer termed a music server.

5. The system of claim 1, further comprising accessing the song via the Internet.

6. The system of claim 4, further comprising accessing the song via the Internet.

7. A system for creating music, comprising:
analyzing a piece of music to identify the number of instruments used to create the piece of music;
separating said piece of music into separate tracks so that each of said tracks has only one of the instruments used to create said piece of music; and
recording together only said tracks that have said instruments that the user would like to hear in said piece of music.
